(19) United States
(12) Patent Application Publication
(10) Pub. No.: US 2009/0022991 A1
(43) Pub. Date: Jan. 22, 2009

(54) METHOD AND DEVICE FOR HOMOGENIZING A VISCOUS SUBSTANCE

(75) Inventors: Pierre Deleplace, Yenne (FR); Jerome Raimond, Mery (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Saint-GobainTechnical Fabrics Europe, Chambery (FR)

(21) Appl. No.: 12/089,556

(22) PCT Filed: Oct. 5, 2006
(86) PCT No.: PCT/FR06/50993

§ 371 Date: Jul. 24, 2008

(30) Foreign Application Priority Data
Oct. 13, 2005 (FR) 04553114

(51) Int. Cl. C03B 5/182; C03C 6/00

(52) U.S. Cl. 428/401; 65/347; 65/134.9; 501/27

(57) ABSTRACT

A melter including an upper chamber configured to receive marbles or the like, and a lower chamber separated from the upper chamber by a porous wall through which, as the result of heating, glass marbles or the like liquefy in the form of a batch. The upper and lower chambers define a melting zone. A refining zone is fed via at least one channel emerging from the melting zone.

The present invention relates to a method and to a device for homogenizing a viscous material. More particularly, the aim of the invention is to provide a method of homogenizing a glass batch in the molten state and a device or melter for implementing this method.

When melting viscous materials, such as molten glass, the melt batch is liable to contain heterogeneous substances (refractory stone residues, unmelted batch particles) and air bubbles when this batch is intended, after passing through a bushing comprising a plurality of orifices followed by attenuation, to form filaments.

Now, the presence of air bubbles dissolved in the glass batch runs the risk of generating defects during fiberizing, the air bubbles being entrained into the glass filament, thus forming inclusions. Generally this type of filament is used for producing support substrates in the microelectronics field and it will be readily understood that if the material forming the substrate has inhomogeneities (air bubble inclusions, even on a microscropic scale), these inhomogeneities, owing to the scale factor, may result in malfunction of the electronic component incorporating this substrate (for example a short circuit).

This phenomenon is more prevalent when the batch raw material is supplied not in the form of pulverulent material but in the form of glass marbles, these glass marbles having to be heated in a suitable device, generally called a “melter”, up to a liquefaction temperature so as to form the viscous batch intended to flow out through orifices generally located on the underside of a bushing, which supports said melter, in order to form the filaments.

U.S. Pat. No. 3,056,846 and U.S. Pat. No. 3,013,096 disclose generally parallelepipedal melters for glass marbles, which define a cavity for receiving the marbles and one of the walls of the cavity is provided with orifices allowing the batch to flow out towards an outlet orifice feeding the bushing.

Now, in this type of melter, the outlet orifice is positioned approximately on the axis of the marble entry zone within the cavity. According to this configuration, the batch after the marbles have melted is rapidly conveyed toward the outlet after a very short residence time within the melter, thus reducing to the minimum the time needed for air bubble degassing.

Counting measurements made on this type of marble melter have shown that there are several thousands of bubbles per kg of melted batch.

The object of the present invention is therefore to alleviate these drawbacks by proposing a device intended for melting marbles, based on a high-performance material, or for technical usage, especially based on glass, which singularly reduces the number of air bubbles within the melted batch.

For this purpose, the melter comprises an upper chamber intended to receive marbles or the like, a lower chamber separated from the upper chamber by a porous wall through which, as the result of heating, glass marbles or the like liquefy in the form of a batch, said upper and lower chambers defining a melting zone, and a central partition separating the melting zone from a refining zone, said refining zone being fed via at least one channel emerging from the melting zone, characterized in that the refining zone is bounded, on the one hand, by external walls of the melter and, on the other hand, by the central partition and a refining wall into which a free end of said channel opens.

Thanks to this refining zone, the melt temperature of the glass batch is above that corresponding to the bubbling temperature of the batch so that the latter can be almost entirely degassed between its feed point in the melter and its point of outflow into the bushing.

In preferred embodiments of the invention, one or more of the following arrangements may optionally furthermore be included:
the refining wall also includes at least one outlet opening for the batch to flow out toward an outlet orifice of the melter;
the refining wall includes a separating wall that defines compartments between the free end of said channel and the outlet opening, this separating wall being provided with at least one opening providing communication between the compartments;
the outlet orifice of the melter is provided with an opening/closing valve;
the valve is controlled by a first level detector positioned in a bushing fed by said melter; and
the melter includes a second level detector that regulates the feed with marbles or the like into the melting zone of said melter.

According to another aspect of the invention, the subject of the invention is a method of homogenizing a batch within a melter comprising a melting zone and a refining zone, which is characterized in that glass marbles or the like (cullet, pulverulent batch raw material) are fed into the melting zone within which the glass marbles or the like are melted after being supplied with heat and brought to the state of the batch, this batch then being drained and ducted into the refining zone in which the batch is degassed, and then this degassed batch is withdrawn towards a production bushing.

According to yet another aspect, the subject of the invention is a glass batch obtained by the method described above, the batch containing at most 1000 gas bubbles per kilogram of material withdrawn, and preferably between 10 and 800 gas bubbles per kilogram of material withdrawn.

The present invention will be more clearly understood on reading the detailed description below of nonlimiting exemplary embodiments illustrated by the figures:

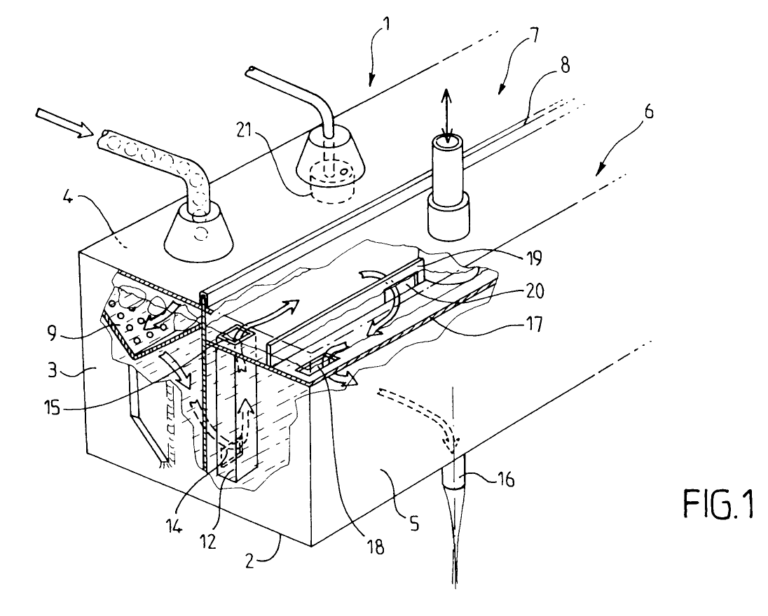

FIG. 1 is a perspective view of the melter forming one subject of the invention;

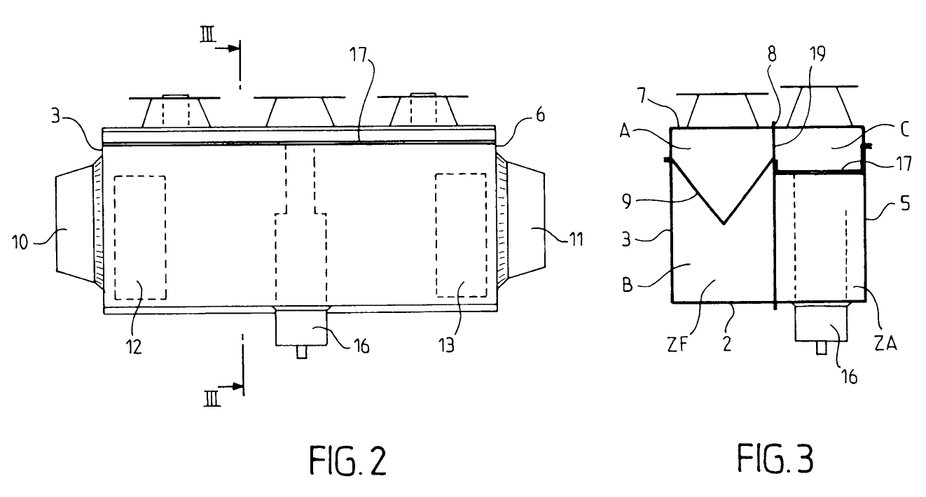

FIG. 2 is a front face of said melter; and

FIG. 3 is a side view of said melter.

The glass marbles produced from a suitable glass composition for making fibers are introduced into the device forming one subject of the invention, usually called a melter, coming from a source of glass marbles intended to be melted.

As a variant, the marble feed may be replaced with a cullet feed or else, more generally, with a feed of pulverulent material for a glass batch which is desired to melt and degas.

After being supplied with heat, the marbles or the like are melted in the melter and produce a batch that feeds a bushing. In this bushing, the temperature of the batch is adjusted so as to achieve a defined viscosity suitable for producing, after attenuation, glass-based filaments of a given linear density. In this example, the base composition of the glass constituting the marbles used is known, for example, as an E-glass composition or other compositions for particular applications that require specific properties (low dielectric loss, high modulus and/or high mechanical strength, good chemical resistance to acids and/or bases, etc.).

The melter forming one subject of the invention shown in FIG. 1 is made of a 90% platinum/10% rhodium alloy and has a generally parallelepipedal shape, this parallelepiped being lined with a refractory gang so as to limit the heat losses.

As may be seen in FIG. 1, the melter 1 is defined, as is conventional, by a bottom wall 2, four side walls (two long sides 4, and 5, and two short sides 3, 6) and a wall forming a lip 7. This closed chamber is in fact separated in its central part, along a direction approximately parallel to the long sides 4, 5 of the parallelepiped, by a central partition 8 defining two separate parts inside the melter, namely a melting zone NZ and a refining zone RZ, these two zones being isolated from each other by this partition 8 (as may be seen in FIG. 3).

Each of these zones will now be described in succession. The melting zone NZ is subdivided into two parts in a plane approximately parallel to the bottom wall 2 or the wall forming the lid 7 of the melter. This separation is achieved by an apertured wall 9 in the form of a grid, the profile of which, shown in the figure, forms a V, the V defining, on the one hand, a zone receiving the marbles or the like (cullet, or pulverulent batch raw material) defining an upper chamber A (which may be seen in FIG. 3) in which the marbles, under the effect of a supply of heat, pass from a solid state to a liquid state, dropping into and melting in a bath of liquid glass, and, on the other hand, in the lower part, a lower chamber B (which may be seen in FIG. 3) for maturation, in which the batch is brought to the desired temperature and viscosity.

The heat is supplied by passing an electric current through the melter 1, the electric current flowing between at least two jaws 10, 11 (which may be seen in FIG. 2) projecting laterally from the side walls 3, 6 of the melter 1, the flow of the electric current resulting, by the Joule effect, in the melting of the marbles, cullet or pulverulent batch raw material.

The central partition 8 is furthermore provided with a plurality of channels 12, 13 or ducts, allowing the batch to pass from the melting zone to the refining zone of the melter.

These channels 12, 13, two in number in this exemplary embodiment, are positioned approximately at each of the edges of the central partition 8 in a direction perpendicular to the bottom wall 2 of the melter 1. Each of the channels 12, 13 has, in its lower part, an opening 14 to which the batch surges and, in its upper part, outlet openings 15. Owing to the convective movement, the batch channeled inside each of the ducts 12, 13 emerges at the free end of each of the channels via the outlet openings 15 into the refining zone of the melter 1.

The refining zone RZ of the melter comprises a plurality of compartments bounded by the judicious positioning of a plurality of partitions, making it possible, because of the partitioning, to impose a considerable residence time on the batch, from the time t it emerges from the channels 12, 13 going from the heating zone to the time t+1, when the batch flows out through the outlet orifice 16 of the melter in order to feed the bushing located underneath.

As may be seen in FIGS. 1 and 3, the refining zone RZ thus comprises three compartments. A first compartment occupies most of the entire volume of the refining zone RZ. This compartment is bounded by three side walls 3, 5, 6 of the melter 1 and the central partition 8 separating the refining zone RZ from the melting zone MZ, and also the bottom wall 2 of the melter on the one hand, and a refining wall 17, extending approximately parallel to the bottom wall 2 and the lid 7 of the melter 1, on the other.

This refining wall 17, located in this exemplary embodiment approximately in the upper part of the melter 1, is provided with a plurality of first and second orifices. It has large dimensions and is in contact with the atmosphere. It defines an exchange volume of small depth compared with the other dimensions, so as to define a free exchange area in contact with the atmosphere, allowing optimum degassing of the batch.

The first orifices 15 are in fact the free outlet ends of the channels 12, 13 that bring the melting zone MZ and the refining zone RZ into communication with each other and the second orifices 18 for the batch to flow toward the outlet orifice 16.

To increase the residence time of the glass batch (this increase in residence time being in fact reflected in an increase in the time required for the batch to travel from its entry into the refining zone RZ to its exit therefrom), the volume bounded by the refining wall 17 and the cover wall 7 of the melter is compartmentalized by a separating wall 19. This separating wall 19, approximately perpendicular to the refining wall 17, defines at least two compartments on either side of the latter. This separating wall 19 produces circumvolutions of the batch from the inlet orifices 15 to the outlet orifices 18, the batch being able to pass between the two compartments only through an opening 20 made in the separating wall 19. The circumvolutions allow degassing of the gas bubbles trapped in the batch at the free surface of the refining wall 17, thus making it possible, at the outlet of the melter, to deliver a glass batch containing at most a few tens of bubbles per kg of extracted material (instead of several thousands by the melters according to the prior art).

The outlet orifice 16 of the melter 1 is provided with an opening/closing valve actuated by an arm that passes through the batch, this arm being connected directly or indirectly by means of a plurality of linking/articulating arms, to a first level detector located in the bushing element placed beneath the melter.

A second level detector 21 is placed in the melting zone MZ of said melter 1 and regulates the inflow of batch raw material (marbles, cullet, pulverulent raw material, etc.). This has the effect of substantially reducing the viscosity of the glass entering the melter and of commencing coarse degassing right from the surface of the melt. This second level detector is in fact formed by a platinum float, obtained by assembling two half-shells welded together, this float floating on the free surface of the magma formed by the molten marbles. To take into account the expansion effects of the gas trapped in the float, an orifice is made in the float, making its release possible.

Using this melter, the method of homogenization according to the invention is characterized in that glass marbles are fed into the melting zone within which the glass marbles are melted after being supplied with heat and are brought to the state of the batch, this batch then being drained and ducted into the refining zone in which the batch is degassed, and then this degassed batch is withdrawn towards a production bushing.

The residence time of the batch in the refining zone is lengthened owing to a plurality of circumvolutions.

The batch that is withdrawn contains at most 1000 gas bubbles per kilogram of material withdrawn, and preferably between 10 and 800 gas bubbles per kilogram of material withdrawn. This batch, which feeds a bushing, makes it possible to produce, after attenuation, filaments with a diameter substantially less than 5 microns and containing fewer than 100 bubbles of gas per kg.

A first method for determining the bubble content consists in using a fabric made from said fibers, in placing the fabric in an indexed liquid beneath a Wood's lamp and in counting the lighter areas as a result of the presence of bubbles.

A second method consists in counting bubbles using a semi-automated optical instrument for defining, by the shadowgraph technique, the diameter histogram ([30, 60]; [60, 90]; [90, 120] in μm, etc.) of the bubbles in the glass droplets sampled beneath the bushing. The droplets, placed in cuvettes filled with an index liquid, are positioned at the intersection of a CDD camera and a light source. To obtain a good statistically representative measurement, it is necessary to count a minimum of 10 grams of specimens with no surface defect, corresponding to about 100 glass droplets. The complete measurement time for a specimen is about 2 hours. A microcomputer detects the bubbles by image analysis. To avoid a false measurement, the operator checks each droplet visually, changing the gain and the offset of the camera and rotating the cuvette through 90° so as to distinguish the droplet and thus eliminate a false detection.

1-9. (canceled)

10. A melter, comprising:
an upper chamber configured to receive marbles or the like;
a lower chamber separated from the upper chamber by a porous wall through which, as a result of heating, glass marbles or the like liquefy in a form of a batch, the upper and lower chambers defining a melting zone; and
a central partition separating the melting zone from a refining zone, the refining zone being fed via at least one channel emerging from the melting zone,
wherein the refining zone is bounded by external walls of the melter and by a central partition and a refining wall into which a free end of the channel opens.

11. The melter as claimed in claim 10, wherein the refining wall further includes at least one outlet opening for the batch to flow out toward an outlet orifice of the melter.

12. The melter as claimed in claim 10, wherein the refining wall includes a separating wall that defines compartments between the free end of the channel and the outlet opening, the separating wall including at least one opening providing communication between the compartments.

13. The melter as claimed in claim 11, wherein the outlet orifice of the melter includes an opening/closing valve.

14. The melter as claimed in claim 13, wherein the valve is controlled by a first level detector positioned in a bushing fed by the melter.

15. The melter as claimed in claim 10, further comprising a float that regulates a feed with the marbles or the like into the melting zone of the melter.

16. A method of homogenizing a batch within a melter including a melting zone and a refining zone, comprising:
feeding glass marbles or the like into the melting zone within which the glass marbles or the like are melted after being supplied with heat and are brought to a state of the batch;
then draining and ducting the batch into the refining zone in which the batch is degassed; and
then withdrawing the degassed batch.

17. A glass batch obtained by the method as claimed in claim 16, wherein the batch contains at most 1000 gas bubbles per kilogram of material withdrawn, or between 10 and 800 gas bubbles per kilogram of material withdrawn.

18. Glass fibers or filaments manufactured from a batch as claimed in claim 17, that contain fewer than 100 gas bubbles per kg and have a diameter of less than 5 microns.
